(19) United States
(12) Patent Application Publication
(10) Pub. No.: US 2014/0163943 A1
(43) Pub. Date: Jun. 12, 2014

(54) SYSTEM FOR MODELING GEOLOGIC STRUCTURES

(71) Applicant: Roxar Software Solutions AS, Stavanger (NO)

(72) Inventors: Alexander BUKHGEYM, Oslo (NO); Thomas BERG, Oslo (NO); Tyson BRIDGER, Stavanger (NO); Erik NILSEN, Oslo (NO); Garrett LEAHY, Stavanger (NO)

(73) Assignee: Roxar Software Solutions AS, Stavanger (NO)

(21) Appl. No.: 14/096,631

(22) Filed: Dec. 4, 2013

(30) Foreign Application Priority Data
Dec. 6, 2012 (NO) 20121473

(51) Int. Cl. G01V 1/28

(52) U.S. Cl. CPC G01V 1/28
USPC 703/6

(57) ABSTRACT

The present invention relates to a system for modeling geologic structures comprising means for receiving geophysical data representing the geological structures and analyzing means for based on at least part of the data; calculating a structural model of said structures, the system also comprising display means for providing a visual presentation of the model and interface means for receiving input from a user, the system being adapted to calculate an updated structural model based on said input.

### BACKGROUND

1. Field of the Invention

The present invention relates to a system for modeling geologic structures comprising means for analyzing data representing the geological structures

2. History of the Related Art

The goal of interpretation is to develop a geologically plausible representation of the subsurface for use in extractive industries, for example the oil and gas industry. The interpretation is typically based on geophysical data, for example seismic data. Conventional workflows require interpreters to build a representation as a collection of many points, representing peaks in seismic amplitude that are interpreted to be geologically-meaningful interfaces. These solutions are typically very labor intensive (with time and ergonomic impacts). A second step is required to use the collected points to generate a geologically plausible model. This typically requires additional time, effort, and expertise.

U.S. 2011/054857 describes a modeling solution, wherein a structural framework is calculated and the model is populated with properties without constructing a 3D geologic grid (conventional solution). It is then used for interactive visualization. The solution presented in the publication is, however, not flexible or able to handle complex situations.

Other examples of geologic modeling are discussed in Wellmann, J. F. et al. “Towards incorporating uncertainty of structural data in 3D geological inversion”, Tectonophysics (2010), doi:10.1016/j.tecto.2010.04.022, U.S. 2003/132934, U.S. 2011246154, and Calcagona, P. et al. “Geological modelling from field data and geological knowledge Part I. Modelling method coupling 3D potential-field interpolation and geological rules”, Physics of the Earth and Planetary Interiors 171 (2008) 147-157. Any of these algorithms could be used to generate a structural model to be used as input according to the present invention.

We present a new method for subsurface interpretation in which a geologically consistent subsurface model is created during the interpretation step. This leads to substantial productivity gains through several fronts. First, fewer points are required during the mapping phase, leading to quicker mapping and decreased ergonomic impact. Second, the interpretation is quality-controlled (QC'd) via immediate feedback from a geologically consistent structural model.

Interpretation is generally performed in general on seismic data, and this invention pertains mainly to the interpretation of seismic data. However, this invention is generally applicable to the interpretation of all data or maps of the subsurface. In conventional seismic interpretation, the user aims to map horizons and faults in the subsurface. An example is disclosed by Quay et al (U.S. Pat. No. 3,899,768), in which seismic properties are displayed in order to develop a geologic model. Geologic models are representations of the subsurface that can be used to make decisions pertinent to extractive industries, for example, where to best drill a well. Geologic models as representations of the subsurface have a long history in the prior art (see for example, Barringer, U.S. Pat. No. 477,633). More recently, these models are developed based on a user's interpretation of seismic data (see for example, Antsey U.S. Pat. No. 3,931,609; Swanson, U.S. Pat. No. 4,991,095).

Interpretation is achieved by the user looking at seismic data and marking a point (“pick”) where a reflection of seismic energy may indicate the presence of an impedance contrast (“horizon”) in the Earth. Discontinuities in horizons may reflect structural deformation and can be interpreted as faults. Faults are picked similarly to horizons, where a point is marked where the interpreter believes the fault crosses a horizon. This type of interpretation is very labor intensive, as it requires the interpreter to make a decision regarding the presence (or absence) of a geologic signal everywhere in the domain where data is present. Further, it has a very large ergonomic impact, frequently resulting in severe repetitive stress injuries even in the presence of a properly assessed workspace.

Technology has progressed to the point where sophisticated algorithms are used to help streamline the process of picking horizons and faults (“auto/ant trackers”), primarily with the goal of increasing speed and reducing ergonomic impact. A software platform combining user interaction and auto-tracking ability is the conventional solution used by industry to solve the interpretation problem. For example, Chittineni (U.S. Pat. No. 4,499,598) and Chittineni (U.S. Pat. No. 4,648,120) developed algorithms for detecting abrupt changes in noisy images. This method can be used to identify faults in seismic data, where there is a rapid lateral change in seismic impedance.

As discussed, auto-tracking algorithms add to speed up the interpretation process. This is done by identifying a feature of interest (e.g., a peak, trough, or zero-crossing of seismic amplitude) at one point in the data volume, and searching the near-by volume for similar structures. Prior art contains many examples of how this is performed. For example, Flinchbaugh (U.S. Pat. No. 4,633,402) describes a method for automatically producing representations of horizons in seismic data. This method follows minima and maxima in seismic traces to determine the lateral extent of a seismic event. Other examples of different methods to achieve the same goals are provided by Howard (U.S. Pat. No. 5,056,066), Hildebrand (U.S. Pat. No. 5,153,858), Hildebrand et al (U.S. Pat. No. 5,251,184), Hildebrand (U.S. Pat. No. 5,432,751), and many others.

Unfortunately, these methods are insufficient for complex reservoirs (for example, where geologic structure changes rapidly relative to the data sampling). Further, inaccuracies and artifacts generated by these methods require a significant QC step, where all errors are corrected before a structural model is built. Additionally, these methods do not honor geologic rules and therefore it can be difficult to determine where the interpretation is incorrect.

Conventional structural modeling begins with an existing interpretation (mapping) of relevant geologic objects (faults/horizons). These mappings are then QC'd for errors, and a stratigraphic framework is developed to relate the mapped objects to a geologic structure. Surfaces are constructed that obey geologic rules, for example fault style; horizon-fault intersections; erosional surfaces; and pinch-outs and on-lapping (for example, Neave, U.S. Pat. No. 7,512,529). Unfortunately this is a time-consuming step that requires expertise; further, the original interpretation frequently requires modification from the structural modeler to build a geologically consistent model. This results in additional “remapping” steps that decrease productivity.

Several workers have developed methods that combine some elements of interpretation and geologic modeling. For example, Pepper et al (U.S.2012/0029827) disclose a method in which an initial interpretation is used to create an initial structural model, after which the seismic data and interpretation are modified to account for geologic deformation of subsurface strata. Subsequent interpretations are performed and the model is adjusted to the new information. Unfortunately, the accuracy of this technique relies on the accuracy of the structural restoration to enhance the visible correlation in the data. Further, this method requires modifying the input seismic data, which adds additional complexity to the process.

Commercially available products claim to combine modeling and interpreting steps. For example, Petrel (Schlumberger) http://www.slb.com/services/software/geo/petrel/seismic/seismic_interpretation.aspxⁱ provides a modeling while interpreting workflow for fault analysis. Unfortunately, this workflow delivers geometric surface representations of faults during the interpretation phase, not a geologically consistent structural model that can be used for decision making. Further, a model based on horizons is not produced in this workflow at all, leading these suites ill suited for a combined interpretation-geomodeling workflow geared towards decision making.

Another example is provided by Dommisse et al (U.S. Pat. No. 7,986,319, U.S.2011/0320182). Here, a system for interpretation is provided in which a three-dimensional surface is developed that represents correlation between well logs. While this method shares many of the advantages described in the present invention, including speed and ease of use, it also has several limitations. For example, this method requires the correlation of well logs in order to develop the 3D interpretation surface, and does not permit a generalized interpretation suite including any or all available geophysical data. Further, the authors acknowledge that the 3D interpretation surface generated by their system is not a geologically consistent structural model; that is to say, a subsequent, time-consuming step is required in order to develop a geologically consistent structural model that can be used for business decisions.

### SUMMARY

The method described here aims to increase productivity by combining the interpretation and modeling steps in a novel way. In our method, a geologically consistent framework is constructed during the interpretation phase; the interpreter therefore only maps points where required by the structural model. The invention being characterized as stated in the accompanying claims.

To solve the labor-intensive and ergonomic challenges associated with conventional solutions, we choose to represent geologic surfaces (e.g. faults, horizons) with sparse data structures. The surface therefore represents an interpolating function between control points chosen by the interpreter. The interpreter determines during the mapping phase whether the existing set of control points accurately represents the feature of interest; if not, the interpreter adds a new control point or modifies the location of an existing control point.

The user needs near real-time feedback while interpreting in order to determine whether or not the digitized control points adequately represent the geologic surface indicated by the data. In principal, this could be provided by any interpolation function (for example, piece-wise linear, b-splines, etc). Unfortunately, these representations do not obey geologic rules and therefore are inappropriate in many common geologic situations (for example, near faults).

We solve this problem by constructing a full, geologically consistent structural model based on (either in entirety or in part) the digitized control points. This model then serves as the interpolation function between the digitized control points.

### BRIEF DESCRIPTION OF THE DRAWINGS

The invention will be discussed more in detail below with reference to the accompanying drawings, illustrating the invention by way of examples.

FIG. 1 illustrates a conventional interpretation and modeling workflow (1a) and the new interpretation and modeling workflow (1b) provided by the system according to the invention.

FIG. 2 illustrates a system diagram demonstrating how the relevant data are combined to generate the model updates.

FIGS. 3-7 illustrates the sequence for producing the model according to the invention.

### DETAILED DESCRIPTION

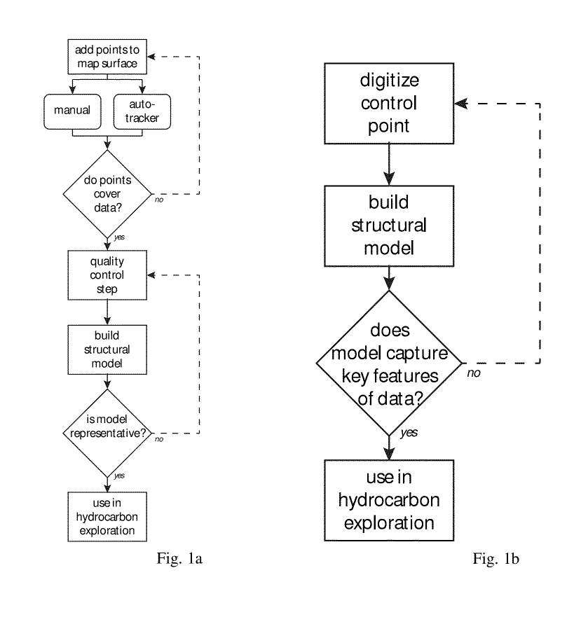

The preferred embodiment of this method would include a variety of geologic rules as implemented in RMS structural modeling today, but any geologically relevant rules could also be used. FIG. 1 outlines the new modeling workflow described here.

FIG. 1a describes a conventional interpretation and modeling workflow. In the first step, points are digitized to delineate a subsurface geobody (horizon, fault, etc). This is achieved either through direct manual input (for example, the user “clicks” at a point on the screen using a pointing device to digitize a single point) or via an algorithmic approach (“auto-tracker”), in which a seed point is placed and the algorithm determines adjacent points based on predetermined criteria (such as waveform correlation for seismic data). Subsequently, the interpreter makes a determination as to whether or not the interpreted/mapped points are representative of the input data. If the answer is no, the user maps additional points, and repeats until the mapped points are representative of the data. This process represents the conventional interpretation workflow. The next step is the beginning of what is typically considered the geologic modeling workflow. It begins with a quality control step in which the modeler examines all sources of input data (wells, seismic interpretations, etc), and determines whether or not the data points available provide adequate constraints on the model building process. Frequent QC pitfalls for seismic data include cycle skips, missed faults, or other poorly or incorrectly mapped features of the geophysical data. After an initial QC phase, the data is combined via a structural modeling algorithm that develops a geologic representation of the subsurface that satisfies the available data and satisfies known geologic rules (as described above). Generally, the modeling process leads the modeler to become aware of features of the data that cause unrealistic features in the geologic model. The modeler then repeats the QC step to control or remove the artifact in the model. When the modeler is satisfied with the geologic model as representative of the original data, it is used to base decisions for subsurface exploration. Here we propose a new workflow that combines the interpretation and modeling workflows (FIG. 1b). In this workflow, the user digitizes a mapped point, and the geologic modeling algorithm immediately calculates a structural model that is consistent with the interpreted data and the known geologic rules. The user then makes a determination as to whether this structural model is representative of the data. If not, subsequent data are added and new representations of the structural model are generated. When the model is deemed representative, it can be used to base decisions for subsurface exploration.

It should be clear to both geomodelers and interpreters that the proposed workflow has several benefits over the conventional approach. First, the combination of the two workflows will lead to substantial productivity gains. Second, by generating a structural model immediately during the interpretation phase, the user may immediately see the consequences of their interpretation (including artifacts) in the structural model. Third, this workflow represents an “additive” process rather than “subtractive,” that is to say, the model is constructed by adding points where detail is necessary rather than removing points where they are not required or lead to errors. This provides a different philosophical approach to the modeling process, and will allow the geoscientist to direct their effort to regions of the model that require it.

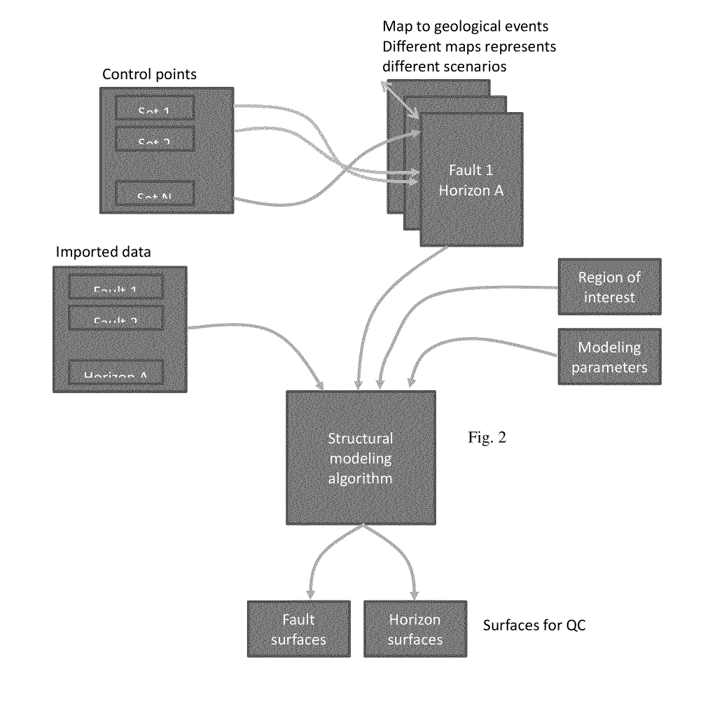

FIG. 2 provides an example system diagram demonstrating how the relevant input data, user-derived data, imported data, and geologic rules are combined to generate the model updates.

If not carefully implemented, a sparse representation of a surface via control points may lead to geologic inconsistencies. For example, a peak in seismic amplitude is generally thought to represent an interface in the Earth; many analytical workflows follow from this assumption including amplitude analysis or inversion. Two alternative embodiments that mitigate this concern are therefore proposed.

In the first embodiment, the structural model is built based upon the interpreted control points, and the solution is damped against a secondary set of points (obtained perhaps via auto-tracking algorithms) via the creation of a cost/penalty function. In this embodiment, the user adds a sparse collection of control points, and a numerical algorithm is used to propose a second set of points based on the control points. This algorithm might be based on known horizon or fault auto-tracking technologies, of which examples of prior art are provided above. Alternatively, any arbitrary interpolating surface (for example, B-spline, etc) satisfying the control points could be used to generate points. Subsequently, a geologic surface is obtained in which the surface satisfies the control points exactly, and satisfies the secondary points to a degree that minimizes a global cost function, related to any surface property, including but not limited to smoothness, difference between secondary points and the representative surface, or other such constraints.

The second embodiment relates to the incorporation of uncertainty in the interpretation process (subject of a separate ROXAR disclosure P4293NO00 incorporated here by way of reference). In this case, it is presumed that a given peak in seismic amplitude represents a distribution of plausible surfaces, and therefore high precision is not required in the mapping phase.

In principle, the structural model that is generated during interpretation may be constrained by any existing subsurface data; for example, well data, well picks (estimates of horizon locations in well logs), etc. These constraints could be used to limit the possible shapes of the structural surfaces.

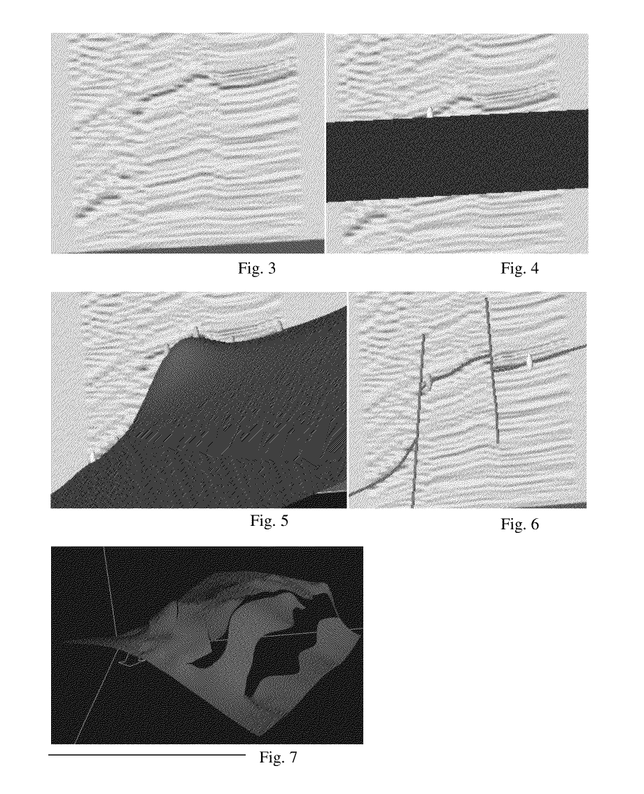

FIGS. 3-7 show sequential iterations of user feedback during the combined interpretation and modeling workflow. First, seismic data is visualized (FIG. 3). Next, the user places a single control point, and a geologic structural model (in this case, a flat horizon) is generated (FIG. 4). Additional control points enhance the representation of the data (FIG. 5). Other geologic objects (for example, faults) can be added (FIG. 6). A system of geologic rules is used to determine how the fault objects intersect horizon objects, and how the horizon and fault surfaces should be generated to satisfy these rules based on the sparse representation of the control points. Finally, a full surface representation can be obtained (FIG. 7). As visualized here, several “tears” are visible in the surface where faults have intersected the geologic horizons.

To summarize the invention thus relates to a system and/or method for modeling geologic structures, where the system comprises means for receiving geophysical data representing the geological structures and analyzing means for based on at least part of the data calculating a structural model of said structures. The receiving means may be any input means providing information to the system either directly through sensors or store information, e.g. from seismic surveys The system also comprises display means for providing a visual presentation of the model and interface means for receiving input from a user, the system being adapted to calculate an updated structural model based on said input that also satisfies the pre-existing data. The method according to the invention thus provides for subsurface interpretation in which a structural model is created during the mapping phase.

According to one embodiment of the invention the structural models comprise information related to the uncertainty of the received data, and said analysis means being adapted to calculate the probability of the presented model relative to the seismic data.

The structural models may also comprise a set of predetermined rules consistent with geological constraints such as horizon-fault intersection, fault throw, isochore thickness thus taking into account the known general features of similar structures. The system may also include input or interface means for adjusting or changing said geologic rules, e.g. after exploration or drilling has produced new knowledge about the geological conditions in the area.

The calculation of the structural model may be performed based on an interpolating function or polynomial, where the interpolating polynomial may be determined subject to additional constraints determined algorithmically during digitization, by being damped against a secondary set of points, e.g. obtained via auto-tracking algorithms, via the creation of a cost/penalty function. This way a more realistic model may be obtained as known errors inherent in the calculation method may be reduced and removed. The first model may also comprise sets of digitized points defining geobodies representing geologically meaningful structures.

The second structural model may be calculated based on user-interaction with the data inputs, including addition, removing, or moving selected control points in said first model, through a user interface such as a computer screen and computer mouse or pad.

The interface of the system may also be adapted to receive additional input data are used as constraints in the structural model calculation, e.g. predetermined information regarding existing horizon or fault representations, well logs or well picks, or other subsurface data.

The information being provided to the system through any suitable interface, e.g. through internet, a keyboard or digital storage means such as hard drives or flash memory.

As is evident the system according to the invention is primarily meant for providing a structural model for use in decisions related to hydrocarbon production or exploration. Other uses, such as surveys for water reservoirs, may also be contemplated.

1. System for modeling geologic structures comprising means for receiving geophysical data representing the geological structures and analyzing means for based on at least part of the data; calculating a structural model of said structures, the system also comprising display means for providing a visual presentation of the model and interface means for receiving input from a user, the system being adapted to calculate an updated structural model based on said input.

2. System according to claim 1, wherein said structural models comprise information related to the uncertainty of the received data, and said analysis means being adapted to calculate the probability of the presented model relative to the seismic data.

3. System according to claim 1 wherein the structural models comprise a set of predetermined rules consistent with geological constraints such as horizon-fault intersection, fault throw, isochore thickness.

4. System according to claim 1, wherein the structural model is created subject to an interpolating function or polynomial.

5. System according to claim 1, wherein the structural model is determined subject to additional constraints for example by being damped against a secondary set of points via the creation of a cost/penalty function

6. System according to claim 1, in which the secondary set of points are obtained algorithmically during digitization, for example obtained via auto-tracking algorithms

7. System according to claim 1, wherein said second structural model is adapted to be calculated based in user-interaction with the data inputs, including addition, removing, or moving selected control points in said first model.

8. System according to 3, comprising input means for adjusting or changing said geologic rules.

9. System according to claim 1, in which said first model comprises sets of digitized points defining geobodies representing geologically meaningful structures.

10. System according to claim 1, being adapted to receive additional input data are used as constraints in the structural model calculation, e.g. predetermined information regarding existing horizon or fault representations, well logs or well picks, or other subsurface data.

11. System according to claim 1, wherein the structural model represents geologic surfaces such as e.g. faults, horizons.

12. System according to claim 11, wherein the geological surfaces are represented by sparse data structures, using an interpolating function between selected control points.

13. Use of a system according to claim 1, for providing a structural model in decisions related to hydrocarbon production or exploration.
